(19) United States
(12) Patent Application Publication
(10) Pub. No.: US 2008/0087387 A1
(43) Pub. Date: Apr. 17, 2008

(54) Blind bottom rail having a labor-saving function

(76) Inventor: Feng-Yuan Chen, Hsin-Tien City (TW)

Correspondence Address: SINORICA, LLC, 528 FALLSGROVE DRIVE, ROCKVILLE, MD, 20850, US

(21) Appl. No.: 11/549,190

(22) Filed: Oct. 13, 2006

(51) Int. Cl. E06B 9/388

(52) U.S. Cl. 160/173 R

(57) ABSTRACT

A blind bottom rail having a labor-saving function comprises a first rail, a second rail and several force-bearing devices with a pulley. Two sides of the first and second rails correspond to each other to let the first rail be fixed in the second rail. Two supporting portions are disposed in the first rail to form a receiving groove. Several through holes are formed at the bottom of the receiving groove. The force-bearing devices respectively correspond to the through holes and are fixed in the receiving groove through the supporting portions. The blind bottom rail can facilitate assembly and give a labor-saving function to the blind.

### BACKGROUND OF THE INVENTION

1. Field of the Invention

The present invention relates to a blind bottom rail and, more particularly, to a blind bottom rail having a labor-saving function.

2. Description of Related Art

Blinds have been widely used for controlling the amount of transmitted light. Moreover, they can also enhance the delicacy of indoor decoration.

As shown in FIGS. 1A and 1B, a conventional horizontal blind 90 comprises a top rail 91, a bottom rail 93, several slats 92 between the top rail 91 and the bottom rail 93, two ladder belts 94, two lift cords 95 and two cord locks 97. Each end of every slat 92 has a hole 96 that is passed through by the one of lift cords 95. The ladder belts 94 are used to series connect the slats and let them be equidistantly hung between the top rail 91 and the bottom rail 93. Each ladder belt 94 has a front cord 941 and a rear cord 942. Each lift cord 95 is stuffed in one of the cord locks 97 under the bottom rail 93 to let a knot 98 of the lift cord 95 be locked at the cord lock 97.

However, when the above blind 90 is in use, the whole bottom rail 93 will be led to move, hence causing labor-consuming operation. Moreover, the arrangement manner between the cord locks 97 and the lift cords 95 will cause inconvenience in assembly. Besides, because the cord locks 97 and the knots 98 are exposed at the bottom rail 93, the whole delicacy of the blind is spoiled.

Accordingly, the present invention aims to propose a more perfect design of the blind bottom rail to solve the above drawbacks in the prior art.

### SUMMARY OF THE INVENTION

An object of the present invention is to provide a blind bottom rail, which can be easily assembled to solve the problem of inconvenient assembly of the conventional blind that makes use of the cord locks.

Another object of the present invention is to provide a blind bottom rail, which has a labor-saving device in the bottom rail to solve the problem of exposed cord locks, hence enhancing the whole delicacy of the blind.

Yet another object of the present invention is to provide a blind bottom rail applied to blinds of various different specifications and sizes to let them have a good labor-saving effect.

To achieve the above objects, the present invention provides a blind bottom rail, which comprises a first rail, a second rail and a plurality of force-bearing devices. The first rail has two supporting portions therein each having a locking hook to form at least a receiving groove. A plurality of through holes is disposed at the bottom of the receiving groove. The second rail has two sides respectively corresponding to those of the first rail. Two fixing portions are respectively disposed at two inner sides of the second rail, and two hook bars are respectively disposed at two outer sides of the first rail. The first rail is fixed in the second rail by using the fixing portions and the hook bars. The force-bearing devices, each having a pulley, respectively correspond to the through holes. The force-bearing devices are located on the locking hooks of the supporting portions to be fixed in the receiving groove. The number of the through holes and the force-bearing devices and the distance between adjacent through holes can be adjusted according to the size of the blind.

### BRIEF DESCRIPTION OF THE DRAWINGS

The various objects and advantages of the present invention will be more readily understood from the following detailed description when read in conjunction with the appended drawing, in which:

FIG. 1A is a diagram of a horizontal blind in the prior art;

FIG. 1B is an enlarged view of the bottom rail in FIG. 1A;

FIG. 2 is a perspective view of the present invention;

FIG. 3 is an exploded perspective view of the present invention;

FIG. 4 is a cross-sectional view of the present invention;

FIG. 5 is another cross-sectional view of the present invention;

FIG. 6 is a diagram according to a first embodiment of the present invention when applied to a blind;

FIG. 7 is a diagram according to a second embodiment of the present invention when applied to a blind;

FIG. 8 is a diagram according to a third embodiment of the present invention when applied to a blind;

FIG. 9 is a diagram according to a fourth embodiment of the present invention when applied to a blind;

FIG. 10 is a diagram according to a fifth embodiment of the present invention when applied to a blind; and

FIG. 11 is a diagram according to a sixth embodiment of the present invention when applied to a blind.

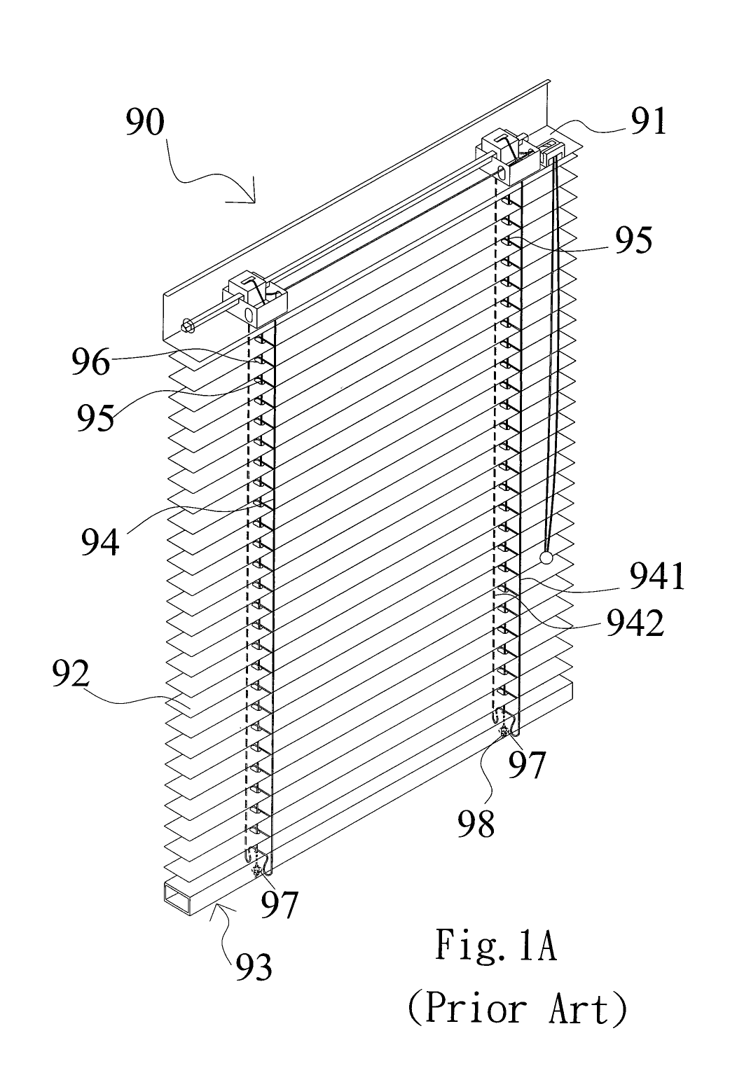

### DETAILED DESCRIPTION OF THE PREFERRED EMBODIMENTS

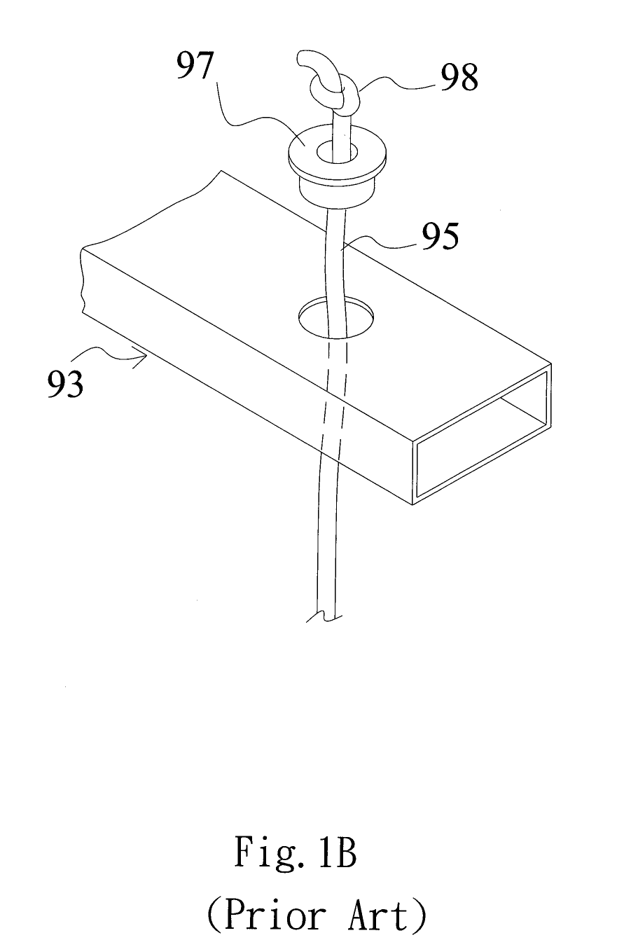

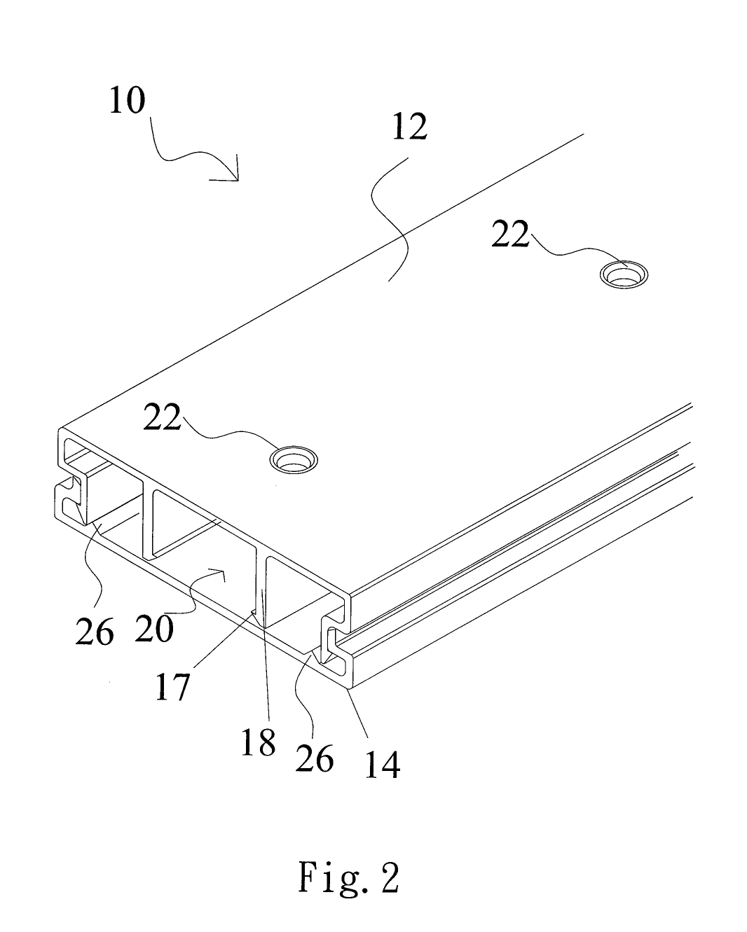

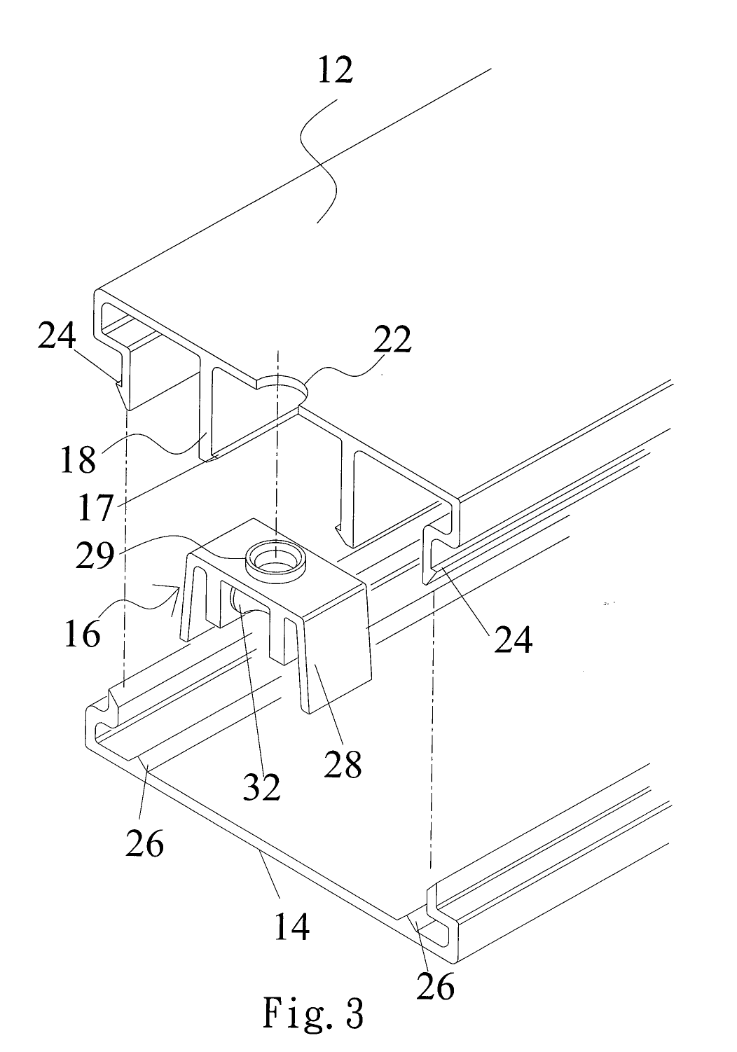

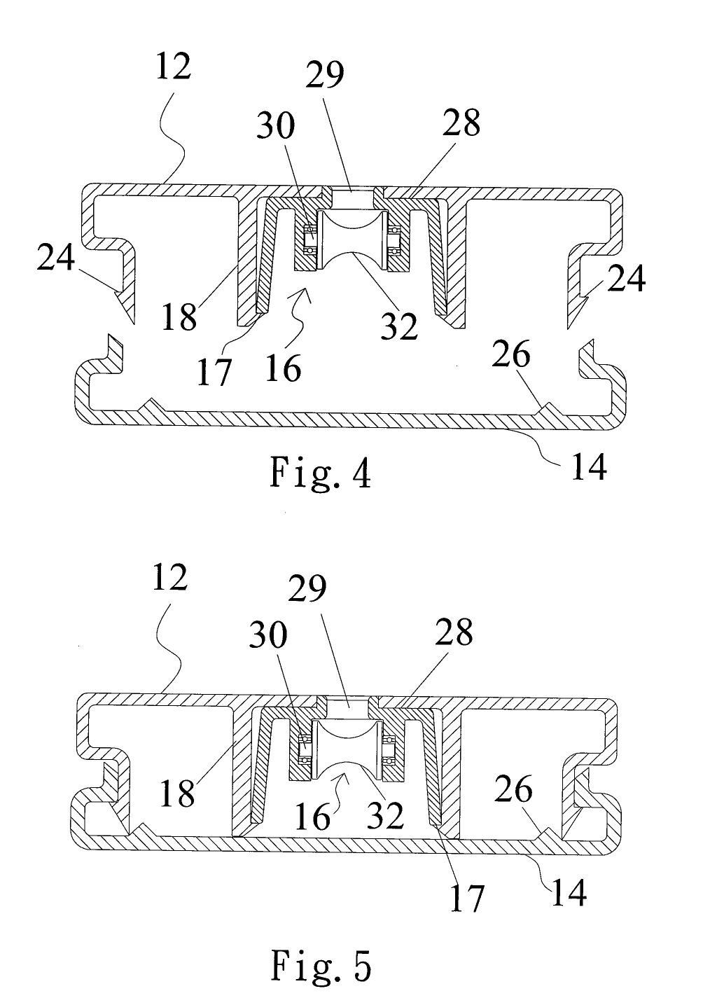

As shown in FIGS. 2 and 3, a blind bottom rail 10 having a labor-saving function comprises a first rail 12, a second rail 14 and several force-bearing devices 16. Two supporting portions 18 each having a locking hook 17 are disposed in the first rail 12 to form a receiving groove 20. Several through holes 22 are formed at the bottom of the receiving groove 20. Two hook bars 24 are respectively disposed at two outer sides of the first rail 12. The second rail 14 has two sides respectively corresponding to those of the first rail 12. Two fixing portions 26 are respectively disposed at two inner sides of the second rail 14. The first rail 12 is locked in the second rail 14 by using the fixing portions 26 and the hook bars 24. Reference is also made to FIGS. 4 and 5. The connection manner of the first rail 12 and the second rail 14 can be more clearly understood.

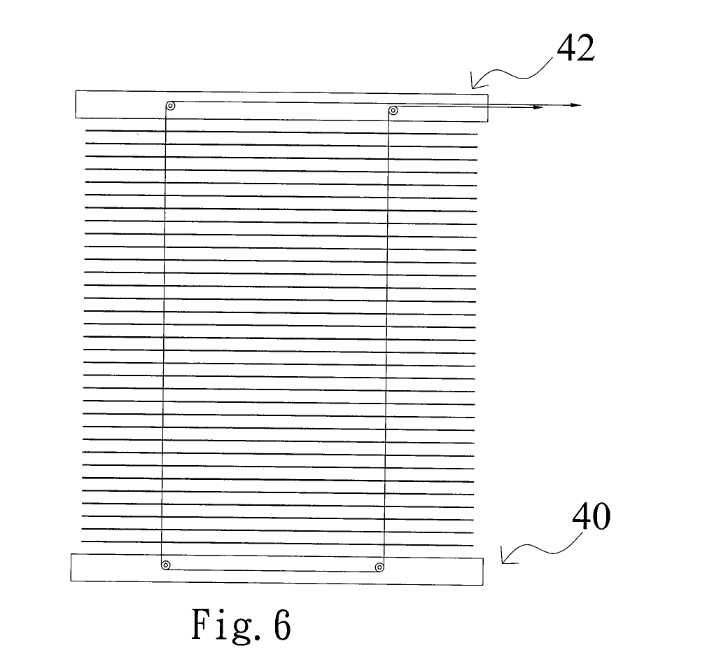

As shown in FIGS. 2, 3, 4 and 5, the force-bearing device 16 has a fixing seat 28 and a bearing 30. The fixing seat 28 is located on the locking hooks 17 of the supporting portion 18 and therefore in the receiving groove 20. The top of the fixing seat 28 has a cord guide hole 29 corresponding to the through hole 22 of the first rail 12 and fixed in the through hole 22. The bearing 30 is embedded in the fixing seat 28 for installation of a pulley 32. The location of the pulley 32 corresponds to those of the cord guide hole 29 and the through hole 22. The design of the cord guide hole 29 can allow the lift cord to pass through the through hole 22 of the first rail 12, pass through the cord guide hole 29 to wind around the pulley 32, and then pass out of the cord guide hole 29. As shown in FIGS. 6, 7, 8, 9, 10 and 11, the blind bottom rail of the present invention is applied to blinds of different specifications and sizes. It is shown that the lift cord passes through the blind bottom rail and then a plurality of slats having holes above the blind bottom rail and finally a blind top rail above the slats

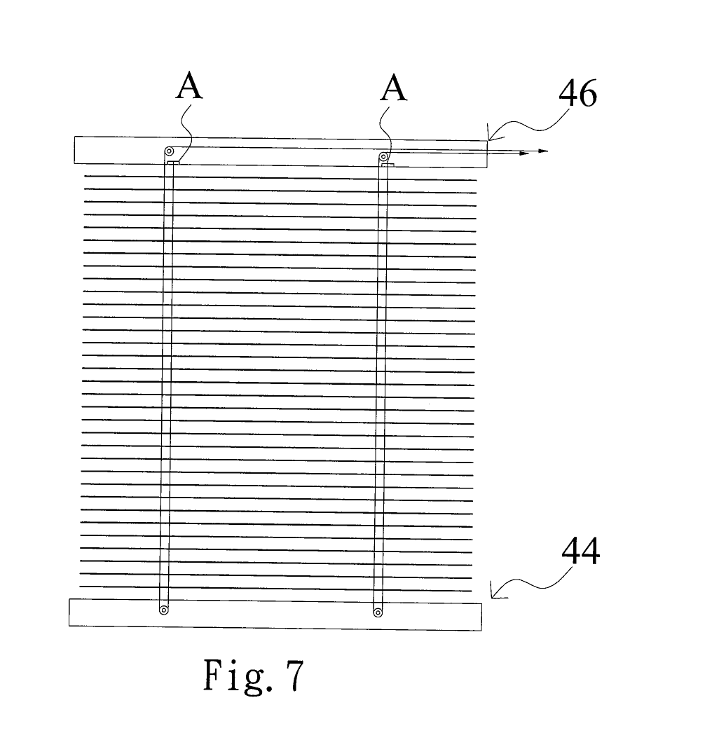

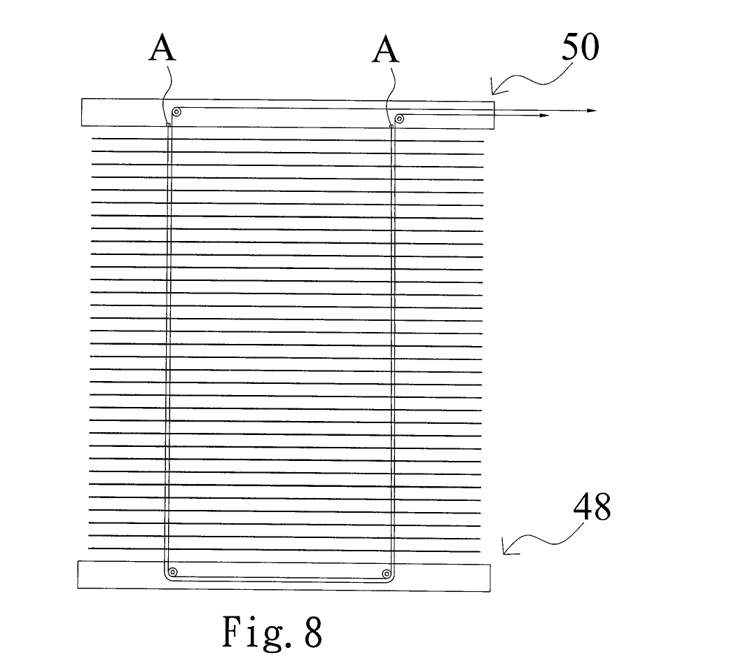

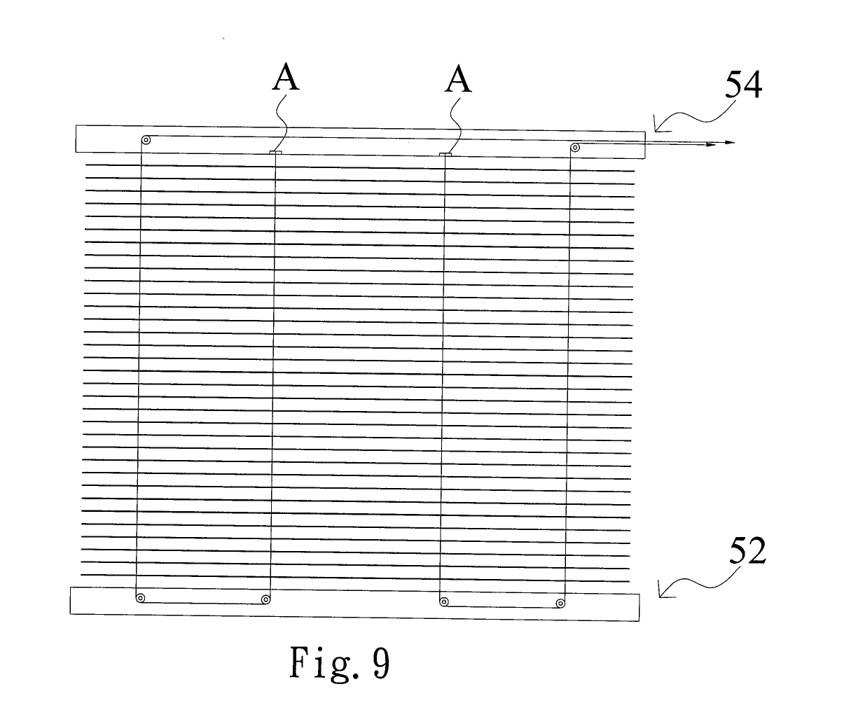

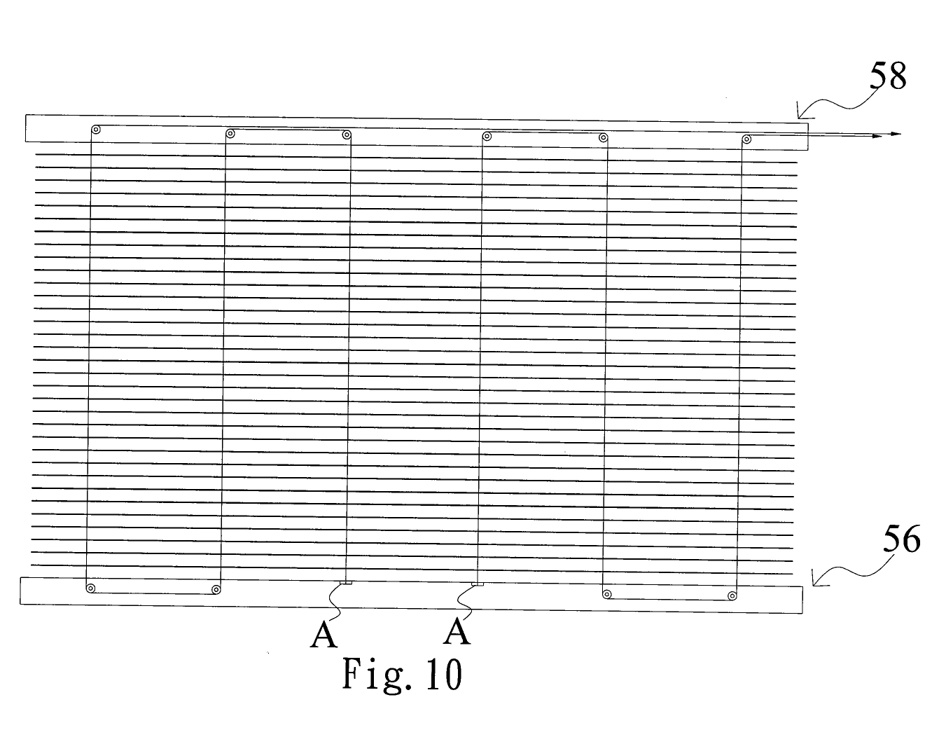

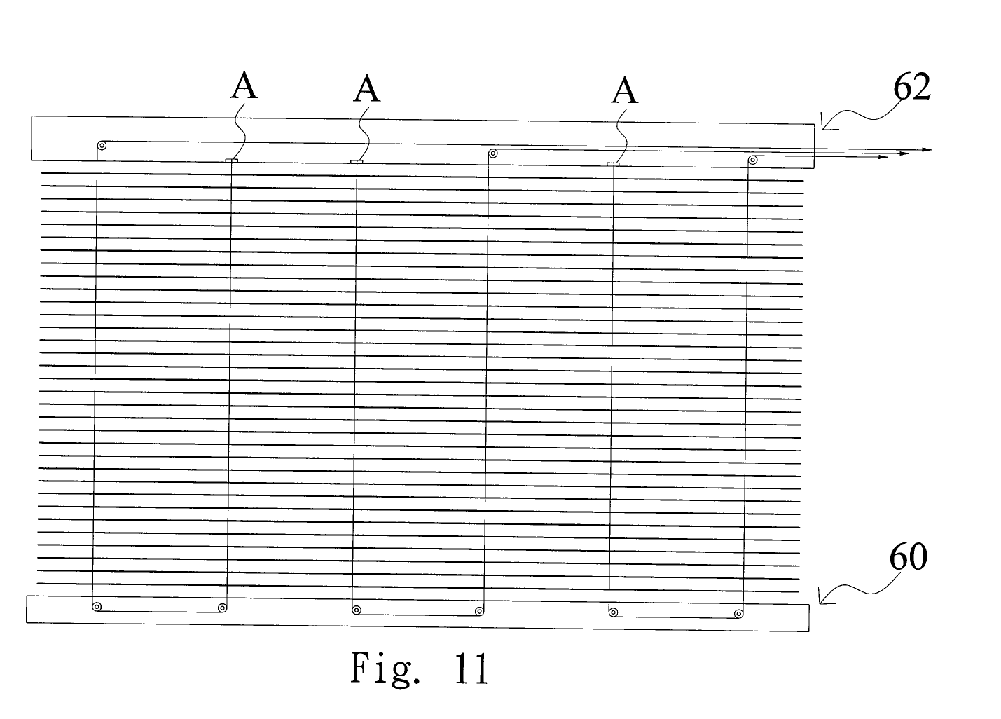

FIGS. 6, 7, and 8 show three different arrangement situations of two lift cords and pulleys of two force-bearing devices when the blind bottom rail has two force-bearing devices. In FIGS. 7 and 8, the ends A for fixing the lift cords are respectively located at blind top rails 46 and 50. FIG. 9 shows the manner how two lift cords pass through pulleys of four force-bearing devices when the blind bottom rail 52 has four force-bearing devices. The ends A for fixing the lift cords are located at the blind top rail 54. In FIG. 10, a blind bottom rail 56 having four force-bearing devices is matched to a blind of a larger size. The ends A for fixing the lift cords are located at the blind bottom rail 56. FIG. 11 shows the arrangement situation of three lift cords and pulleys of six force-bearing devices when the blind bottom rail has six force-bearing devices. The ends A for fixing the lift cords are located at the blind top rail 62. Therefore, the number of the through holes and force-bearing devices of the blind bottom rail of the present invention and the distance between adjacent through holes can be adjusted according to the size of the blind. Moreover, by applying the movable pulley structure of the blind bottom rail of the present invention, a labor-saving effect can be accomplished.

To sum up, the blind bottom rail having a labor-saving function of the present invention has two corresponding rails that are locked together, and makes use of a receiving space formed between supporting portions and through holes to install force-bearing devices in the bottom rail. Therefore, the blind bottom rail can be easily assembled to solve the problem of inconvenient assembly of the conventional blind that makes use of exposed cord locks. Moreover, because the force-bearing devices are disposed in the bottom rail, the whole delicacy of the blind can be enhanced.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A blind bottom rail having a labor-saving function comprising:
a first rail having two supporting portions therein to form at least a receiving groove, a plurality of through holes being disposed at a bottom of said receiving groove;
a second rail having two sides respectively corresponding to two sides of said first rail to make said first rail fixed in said second rail; and
a plurality of force-bearing devices respectively corresponding to said through holes, and said force-bearing devices being fixed in said receiving groove through said supporting portions.

2. The blind bottom rail having a labor-saving function as claimed in claim 1, wherein two fixing portions are respectively disposed at two inner sides of said second rail, and two hook bars are respectively disposed at two outer sides of said first rail, and said first rail is locked in said second rail by using said fixing portions and said hook bars.

3. The blind bottom rail having a labor-saving function as claimed in claim 1, wherein each of said two supporting portions has a locking hook, and said force-bearing devices are located on said locking hook and thus fixed in said receiving groove.

4. The blind bottom rail having a labor-saving function as claimed in claim 3, wherein each of said force-bearing devices comprises:
a fixing seat located on said locking hook of each said two supporting portions and thus in said receiving groove, and said fixing seat has a cord guide hole that corresponds to one of said through holes of said first rail;
a bearing embedded in said fixing seat; and
at least a pulley installed in said bearing and corresponding to said cord guide hole.

5. The blind bottom rail having a labor-saving function as claimed in claim 4, wherein said cord guide hole is used for at least a lift cord to goes into said cord guide hole to wind around said pulley and then out from said cord guide hole.

6. The blind bottom rail having a labor-saving function as claimed in claim 5, wherein a blind top rail is above said blind bottom rail and a plurality of slats having holes between said blind top rail and a blind bottom rail, and one end of said lift cord goes into said cord guide hole to wind around said pulley and then out from said cord guide hole to pass through said holes of said slats to reach said blind top rail.
